(19) United States
(12) Patent Application Publication
(10) Pub. No.: US 2024/0402466 A1
(43) Pub. Date: Dec. 5, 2024

(54) OPTICAL IMAGING LENS

(71) Applicant: Calin Technology Co., Ltd., Taichung City (TW)

(72) Inventors: SHANG-RU YANG, Taichung City (TW); MING-JIA CAI, Taichung City (TW); MING-JUN LIU, Taichung City (TW)

(73) Assignee: Calin Technology Co., Ltd., Taichung City (TW)

(21) Appl. No.: 18/235,688

(22) Filed: Aug. 18, 2023

(30) Foreign Application Priority Data
Jun. 1, 2023 (TW) 112120571

(51) Int. Cl. G02B 13/00; G02B 9/64

(52) U.S. Cl. CPC G02B 13/0045; G02B 9/64

(57) ABSTRACT

An optical imaging lens, in order from an object side to an image side along an optical axis, includes a first lens assembly, an aperture, and a second lens assembly. The first lens assembly includes a first lens that is a negative meniscus having negative refractive power, a second lens that is a biconcave lens having negative refractive power, and a third lens that is a biconvex lens having positive refractive power. The second lens assembly includes a fourth lens that is a biconvex lens having positive refractive power, a fifth lens that is a biconcave lens having negative refractive power, a sixth lens that is a biconvex lens having positive refractive power, and a seventh lens that is a negative meniscus having negative refractive power.

### BACKGROUND OF THE INVENTION

### Technical Field

The present invention generally relates to an optical image capturing system, and more particularly to an optical imaging lens, which provides a better optical performance of high image quality and low distortion.

### Description of Related Art

In recent years, with advancements in portable electronic devices having camera functionalities, the demand for an optical image capturing system is raised gradually. The image sensing device of the ordinary photographing camera is commonly selected from a charge-coupled device (CCD) or a complementary metal-oxide-semiconductor sensor (CMOS Sensor). Besides, as advanced semiconductor manufacturing technology enables the minimization of the pixel size of the image sensing device, the development of the optical image capturing system towards the field of high pixels. Moreover, with the advancement in drones and driverless autonomous vehicles, Advanced Driver Assistance System (ADAS) plays an important role, collecting environmental information through various lenses and sensors to ensure the driving safety of the driver. Furthermore, as the image quality of the automotive lens changes with the temperature of an external application environment, the temperature requirements of the automotive lens also increase. Therefore, the requirement for high imaging quality is rapidly raised.

Good imaging lenses generally have the advantages of low distortion, high resolution, etc. In practice, small size and cost must be considered. Therefore, it is a big problem for designers to design a lens with good imaging quality under various constraints.

### BRIEF SUMMARY OF THE INVENTION

In view of the reasons mentioned above, the primary objective of the present invention is to provide an optical imaging lens that provides a better image quality.

The present invention provides an optical imaging lens, in order from an object side to an image side along an optical axis, including a first lens assembly, an aperture, and a second lens assembly, wherein the first lens assembly comprising, in order from the object side to the image side along the optical axis, a first lens having negative refractive power, a second lens having negative refractive power, and a third lens having positive refractive power, wherein an object-side surface of the first lens is a convex surface toward the object side, and an image-side surface of the first lens is a concave surface toward the image side; both of an object-side surface of the second lens and an image-side surface of the second lens are concave surface; both of an object-side surface of the third lens and an image-side surface of the third lens are convex surfaces. The second lens assembly comprising, in order from the object side to the image side along the optical axis, a fourth lens having positive refractive power, a fifth lens having negative refractive power, a sixth lens having positive refractive power, and a seventh lens having negative refractive power, wherein both of an object-side surface of the fourth lens and an image-side surface of the fourth lens are convex surfaces; both of an object-side surface of the fifth lens and an image-side surface of the fifth lens are concave surface; both of an object-side surface of the sixth lens and an image-side surface of the sixth lens are convex surfaces; an object-side surface of the seventh lens is a concave surface toward the object side, and an image-side surface of the seventh lens is a convex surface toward the image side.

The present invention further provides an optical imaging lens, in order from an object side to an image side along an optical axis, comprising a first lens assembly, an aperture, and a second lens assembly, wherein the first lens assembly comprising, in order from the object side to the image side along the optical axis, a first lens having negative refractive power, a second lens having negative refractive power, and a third lens having positive refractive power. The second lens assembly comprising, in order from the object side to the image side along the optical axis, a fourth lens having positive refractive power, a fifth lens having negative refractive power, a sixth lens having positive refractive power, and a seventh lens having negative refractive power, wherein an object-side surface of the seventh lens and an image-side surface of the sixth lens are adhered to form a compound lens having positive refractive power; wherein the optical imaging lens satisfies: L7R2/V7<1; L7R2 is a radius of curvature of an image-side surface of the seventh lens; V7 is an Abbe number of the seventh lens.

With the aforementioned design, the optical imaging lens is composed of seven lenses could achieve the effect of good image quality by utilizing the refractive power arrangement and the shape of the lenses. The optical imaging lens satisfies: L7R2/V7 <1, which could achieve the effect of good image quality.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1A is a schematic view of the optical imaging lens according to a first embodiment of the present invention;

FIG. 1B is a diagram showing, from left to right, the longitudinal spherical aberration, the astigmatic field curves, and the distortion of the optical imaging lens according to the first embodiment of the present invention;

FIG. 2A is a schematic view of the optical imaging lens according to a second embodiment of the present invention; and

FIG. 2B is a diagram showing, from left to right, the longitudinal spherical aberration, the astigmatic field curves, and the distortion of the optical imaging lens according to the second embodiment of the present invention.

### DETAILED DESCRIPTION OF THE INVENTION

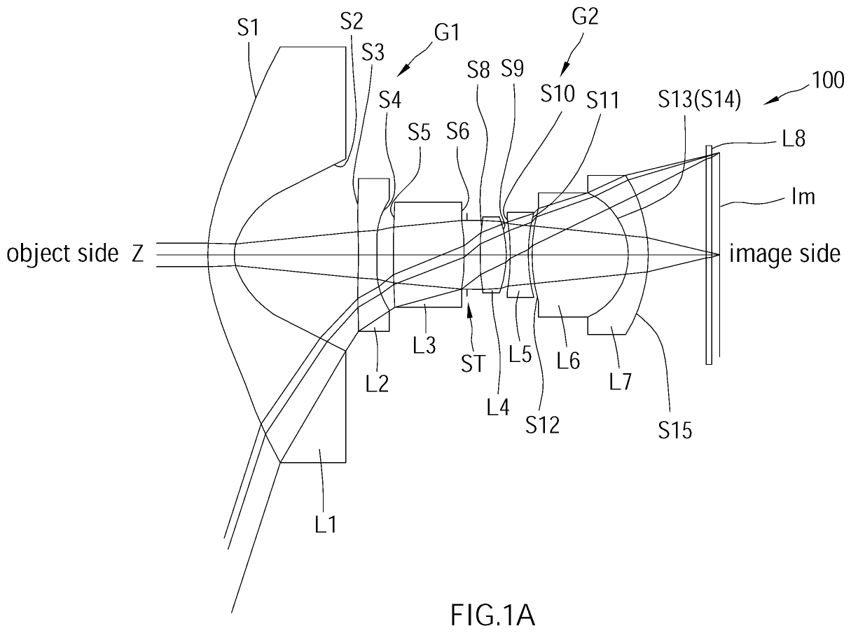

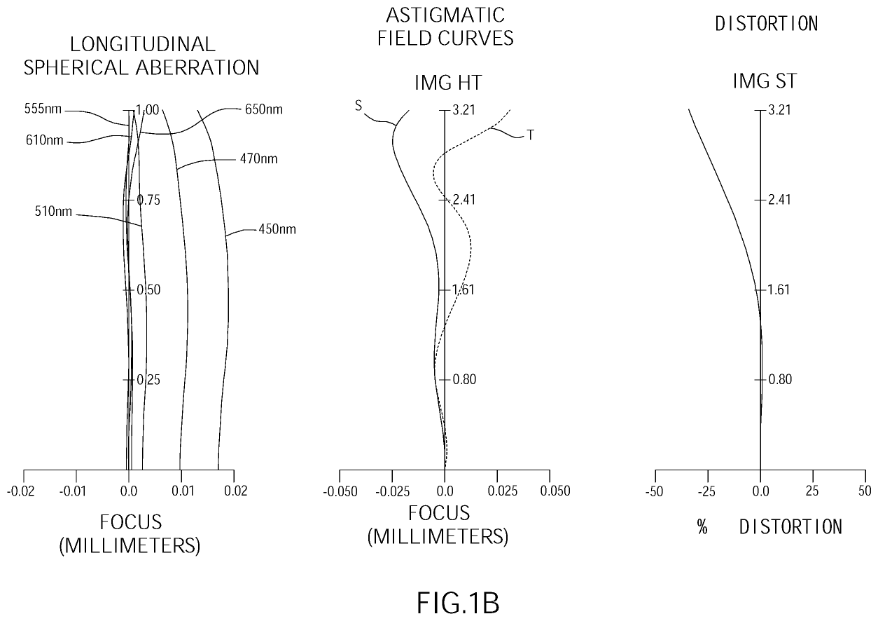

An optical imaging lens 100 according to a first embodiment of the present invention is illustrated in FIG. 1A, which includes, in order along an optical axis Z from an object side to an image side, a first lens assembly G1, an aperture ST, and a second lens assembly G2.

In the current embodiment, the first lens assembly G1 has positive refractive power and includes in order along the optical axis Z from the object side to the image side. a first lens L1, a second lens L2, and a third lens L3; the second lens assembly G2 has positive refractive power and includes in order along the optical axis Z from the object side to the image side, a fourth lens L4; a fifth lens L5, a sixth lens L6, and a seventh lens L7.

The first lens L1 is a negative meniscus with negative refractive power; an object-side surface S1 of the first lens L1 is a convex surface toward the object side, and an image-side surface S2 of the first lens L1 is a concave surface toward the image side, wherein a surface of the first lens L1 toward the object side is protruded to form the object-side surface S1, a part of a surface of the first lens L1 toward the image side is recessed to form the image-side surface S2, and the optical axis Z passes through the object-side surface S1 and the image-side surface S2 of the first lens L1.

The second lens L2 is a biconcave lens with negative refractive power; an object-side surface S3 of the second lens L2 is a concave surface toward the object side, and an image-side surface S4 of the second lens L2 is a concave surface toward the image side, wherein a surface of the second lens L2 toward the object side is recessed to form the object-side surface S3, a part of a surface of the second lens L2 toward the image side is recessed to form the image-side surface S4, and the optical axis Z passes through the object-side surface S3 and the image-side surface S4 of the second lens L2.

The third lens L3 is a biconvex lens with positive refractive power; an object-side surface S5 of the third lens L3 is a convex surface toward the object side, and an image-side surface S6 of the third lens L3 is a convex surface toward the image side, wherein a surface of the third lens L3 toward the object side is protruded to form the object-side surface S5, a surface of the third lens L3 toward the image side is protruded to form the image-side surface S6, and the optical axis Z passes through the object-side surface S5 and the image-side surface S6 of the third lens L3.

The fourth lens L4 is a biconvex lens (i.e., both of an object-side surface S8 of the fourth lens L4 and an image-side surface S9 of the fourth lens L4 are convex surfaces) with positive refractive power; a part of a surface of the fourth lens L4 toward the object side is protruded to form the object-side surface S8, a surface of the fourth lens L4 toward the image side is protruded to form the image-side surface S9, and the optical axis Z passes through the object-side surface S8 and the image-side surface S9 of the fourth lens L4.

The fifth lens L5 is a biconcave lens (i.e., both of an object-side surface S10 of the fifth lens L5 and an image-side surface S11 of the fifth lens L5 are concave surfaces) with negative refractive power; a part of a surface of the fifth lens L5 toward the object side is recessed to form the object-side surface S10, a part of a surface of the fifth lens L5 toward the image side is recessed to form the image-side surface S11, and the optical axis Z passes through the object-side surface S10 and the image-side surface S11 of the fifth lens L5.

The sixth lens L6 is a biconvex lens (i.e., both of an object-side surface S12 of the sixth lens L6 and an image-side surface S13 of the sixth lens L6 are convex surfaces) with positive refractive power; a part of a surface of the sixth lens L6 toward the object side is protruded to form the object-side surface S12, a surface of the sixth lens L6 toward the image side is protruded to form the image-side surface S13, and the optical axis Z passes through the object-side surface S12 and the image-side surface S13 of the sixth lens L6.

The seventh lens L7 is a negative meniscus with negative refractive power; an object-side surface S14 of the seventh lens L7 is a concave surface toward the object side, and an image-side surface S15 of the seventh lens L7 is a convex surface toward the image side, and the optical axis Z passes through the object-side surface S14 and the image-side surface S15 of the seventh lens L7. As shown in FIG. 1A, the object-side surface S14 of the seventh lens L7 and the image-side surface S13 of the sixth lens L6 are adhered to form a

Additionally, the optical imaging lens 100 further includes an infrared filter L8, wherein the infrared filter L8 is disposed between the seventh lens L7 and an image plane Im, thereby filtering out excess infrared rays in an image light passing through the optical imaging lens 100 to effectively enhance image quality.

In order to keep the optical imaging lens 100 in good optical performance and high imaging quality, the optical imaging lens 100 further satisfies:

$$( 1 ) L 7 R 2 / V 7 < 1 ; \\ ( 2 ) 1 \leq f 3 / f ( 4 , 5 , 6 , 7 ) \leq 3 ; \\ ( 3 ) f 6 / f ( 4 , 5 , 6 , 7 ) \leq 1 ; \\ ( 4 ) - 3.5 \leq f 7 / f ( 4 , 5 , 6 , 7 ) ; \\ ( 5 ) 1 \leq f 3 / f 6 \leq 5 ; - 3.5 \leq f 4 / f 5 ; - 3.5 \leq f 6 / f 7 ; \\ ( 6 ) 1 \leq f ( 4 , 5 , 6 , 7 ) / F \leq 5 ; \\ ( 7 ) - 1 \leq 1 / f 1 + 1 / f 2 + 1 / f 3 + 1 / f 4 + 1 / f 5 + 1 / f 6 + 1 / f 7 \leq 1 ; \\ ( 8 ) V 3 > 25 ; V 7 > 25 ; \\ ( 9 ) - 3.5 \leq f ( 4 , 5 , 6 , 7 ) / L 7 R 2 ;$$

wherein F is a focal length of the optical imaging lens 100; f1 is a focal length of the first lens L1; f2 is a focal length of the second lens L2; f3 is a focal length of the third lens L3; f4 is a focal length of the fourth lens L4; f5 is a focal length of the fifth lens L5; f6 is a focal length of the sixth lens L6; f7 is a focal length of the seventh lens L7; f(4,5,6,7) is a focal length of the second lens assembly G2; V3 is an Abbe number of the third lens L3; V7 is an Abbe number of the seventh lens L7; L7R2 is a radius of curvature of the image-side surface S15 of the seventh lens L7.

Parameters of the optical imaging lens 100 of the first embodiment of the present invention are listed in following Table 1, including the focal length F of the optical imaging lens 100 (also called an effective focal length (EFL)), a F-number (Fno), a maximal field of view (DFOV), a radius of curvature (R) of each lens, a distance (D) between each surface and the next surface on the optical axis Z, a refractive index (Nd) of each lens, an Abbe number (Vd) of each lens, the focal length of each lens, a refractive power of each lens, wherein a unit of the focal length, the radius of curvature, and the distance is millimeter (mm). The data listed below are not a limitation of the present invention, wherein the parameters that could be appropriate changed by one with ordinary skill in the art after referring the present invention should still fall within the scope of the present invention.

TABLE 1
F = 1.76 mm; Fno = 2.4; DFOV = 140 deg; TTL =
18.4 mm; 1/2IMG HT = 3.2 mm

| Sur- | | | | | Focal | | Refractive |
|---|---|---|---|---|---|---|---|
| face | R(mm) | D(mm) | Nd | Vd | length | Note | power |
| S1 | 4.673 | 0.95 | 1.545 | 55.99 | −4.226 | L1 | negative |
| S2 | 1.434 | 4.41 | | | | | |
| S3 | −10.338 | 0.65 | 1.536 | 55.98 | −11.816 | L2 | negative |
| S4 | 16.890 | 0.57 | | | | | |
| S5 | 25.068 | 2.54 | 1.755 | 27.51 | 6.885 | L3 | positive |
| S6 | −6.324 | 0.10 | | | | | |
| ST | | 0.47 | | | | Aperture | |
| | | | | | | ST | |
| S8 | 9.426 | 0.93 | 1.535 | 55.71 | 4.232 | L4 | positive |
| S9 | −2.890 | 0.13 | | | | | |
| S10 | −7.858 | 0.65 | 1.642 | 22.41 | −4.438 | L5 | negative |
| S11 | 4.674 | 0.13 | | | | | |
| S12 | 4.857 | 3.43 | 1.620 | 60.29 | 2.866 | L6 | positive |
| S13 | −2.056 | | | | | | |
| S14 | −2.056 | 0.70 | 1.755 | 27.51 | −5.777 | L7 | negative |
| S15 | −4.433 | 2.06 | | | | | |
| | Infinity | 0.20 | 1.517 | 64.17 | | Infrared | |
| | | | | | | filter L8 | |
| | Infinity | 0.30 | | | | | |
| Im | Infinity | | | | | | |

It can be seen from Table 1 that, in the current embodiment, the focal length F of the optical imaging lens 100 is 1.76 mm, and the Fno is 2.4, and the DFOV is 140 degrees, wherein f1=−4.226 mm; f2=−11.816 mm; f3=6.885 mm; f4=4.232 mm; f5=−4.438 mm; f6=2.866 mm; f7=−5.777 mm; f(1,2,3)=204.69 mm, wherein f(1,2,3) is a focal length of the first lens assembly G1; f(4,5,6,7)=5.014 mm.

Additionally, based on the above detailed parameters, detailed values of the aforementioned conditional formula in the first embodiment are as follows:

$$( 1 ) L 7 R 2 / V 7 = - 0.161 ; \\ ( 2 ) f 3 / f ( 4 , 5 , 6 , 7 ) = 1.373 ; \\ ( 3 ) f 6 / f ( 4 , 5 , 6 , 7 ) = 0.572 ; \\ ( 4 ) f 7 / f ( 4 , 5 , 6 , 7 ) = - 1.152 ; \\ ( 5 ) f 3 / f 6 = 2.402 ; f 4 / f 5 = - 0.954 ; f 6 / f 7 = - 0.496 ; \\ ( 6 ) f ( 4 , 5 , 6 , 7 ) / F = 2.849 ; \\ ( 7 ) 1 / f 1 + 1 / f 2 + 1 / f 3 + 1 / f 4 + 1 / f 5 + 1 / f 6 + 1 / f 7 = 0.0108 ; \\ ( 8 ) V 3 = 27.51 ; V 7 = 27.51 ; \\ ( 9 ) f ( 4 , 5 , 6 , 7 ) / L 7 R 2 = - 1.131 .$$

With the aforementioned design, the first lens assembly G1 and the second lens assembly G2 according to the first embodiment satisfy the aforementioned conditions (1) to (9) of the optical imaging lens 100.

Moreover, an aspheric surface contour shape Z of each of the object-side surface S1 of the first lens L1, the image-side surface S2 of the first lens L1, the object-side surface S3 of the second lens L2, the image-side surface S4 of the second lens L2, the object-side surface S8 of the fourth lens L4, the image-side surface S9 of the fourth lens L4, the object-side surface S10 of the fifth lens L5, and the image-side surface S11 of the fifth lens L5 of the optical imaging lens 100 according to the first embodiment could be obtained by following formula:

$$Z = \frac{{ch}^{2}}{1 + \sqrt{1 - ( 1 + k ) {c}^{2} {h}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A4, A6, A8, A10, A12, A14, and A16 respectively represents different order coefficient of h.

The conic constant k of each of the object-side surface S1 of the first lens L1, the image-side surface S2 of the first lens L1, the object-side surface S3 of the second lens L2, the image-side surface S4 of the second lens L2, the object-side surface S8 of the fourth lens L4, the image-side surface S9 of the fourth lens L4, the object-side surface S10 of the fifth lens L5, and the image-side surface S11 of the fifth lens L5 of the optical imaging lens 100 according to the first embodiment and the different order coefficient of A4, A6, A8, A10, A12, A14, and A16 are listed in following Table 2:

TABLE 2

| Surface | K | A4 | A6 | A8 | A10 | A12 | A14 | A16 |
|---|---|---|---|---|---|---|---|---|
| S1 | −1.84E+00 | −1.24E−05 | −1.34E−04 | 7.59E−06 | −1.94E−07 | 2.54E−09 | −1.35E−11 | 0.00E+00 |
| S2 | −9.10E−01 | 1.16E−02 | −1.63E−04 | 1.48E−04 | −3.60E−05 | 1.54E−06 | −2.44E−08 | 0.00E+00 |
| S3 | −5.79E+01 | 1.68E−02 | −2.80E−03 | 1.79E−04 | −2.06E−05 | 3.03E−06 | −1.15E−07 | 0.00E+00 |
| S4 | 8.84E+01 | 3.31E−02 | −1.73E−03 | −6.84E−05 | 2.92E−04 | −3.87E−05 | 3.49E−06 | 0.00E+00 |
| S8 | 1.52E+01 | 2.61E−03 | 7.74E−04 | −6.59E−04 | 9.40E−04 | −2.15E−04 | 1.55E−05 | 0.00E+00 |
| S9 | −1.37E+00 | −1.06E−02 | 1.02E−02 | −2.65E−03 | 7.15E−04 | −8.88E−05 | 2.01E−06 | 0.00E+00 |
| S10 | 1.17E+00 | −1.43E−02 | 8.48E−03 | −1.23E−03 | −3.60E−04 | 2.08E−05 | −1.41E−06 | 0.00E+00 |
| S11 | −3.54E+00 | 5.18E−03 | 4.35E−04 | 1.64E−04 | −2.67E−04 | 4.00E−05 | −2.61E−06 | 0.00E+00 |

Taking optical simulation data to verify the imaging quality of the optical imaging lens 100, wherein FIG. 1B is a diagram showing the longitudinal spherical aberration, the astigmatic field curves, and the distortion of the optical imaging lens according to the first embodiment. The graphics shown in FIG. 1B are within a standard range. In this way, the optical imaging lens 100 of the first embodiment could effectively enhance image quality.

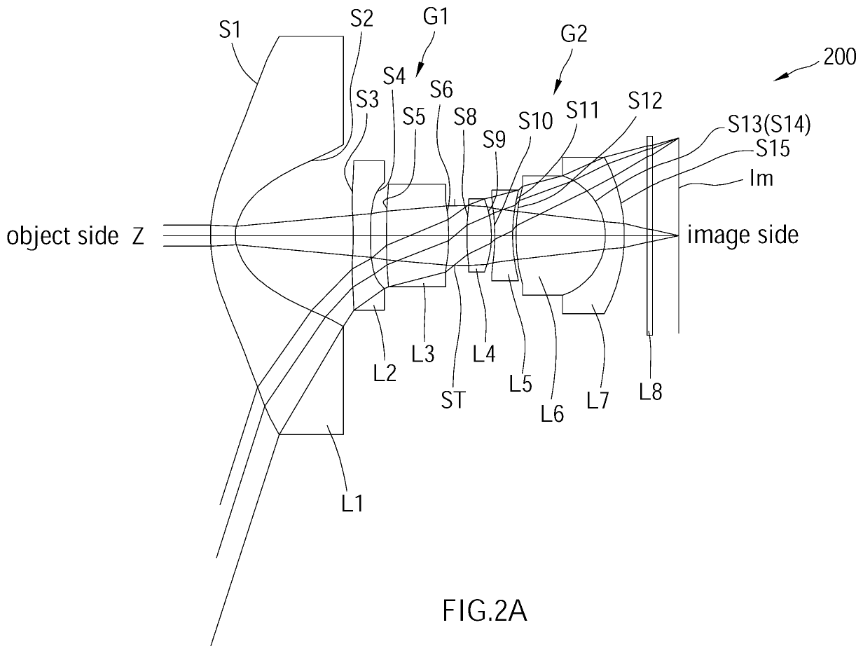

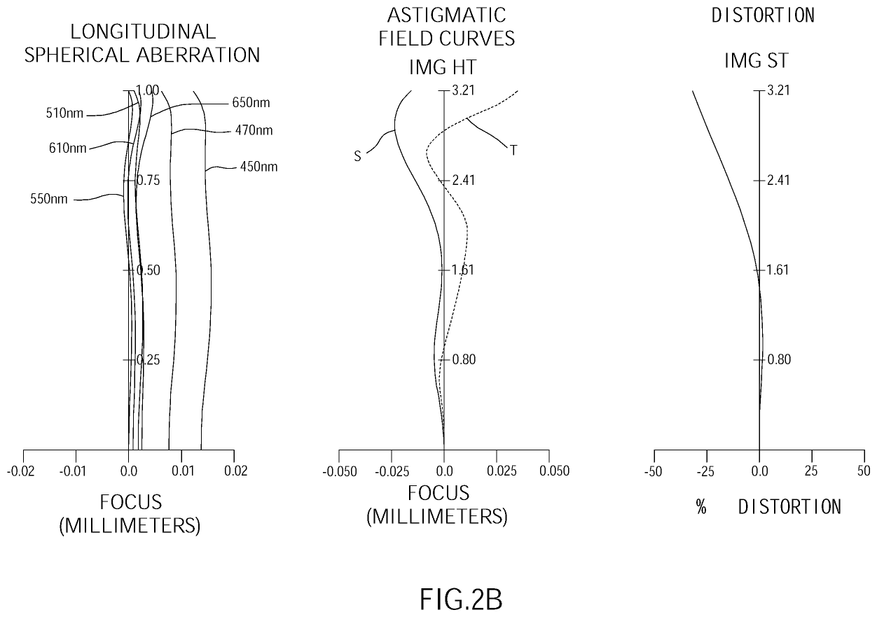

An optical imaging lens 200 according to a second embodiment of the present invention is illustrated in FIG. 2A, which includes, in order along an optical axis Z from an object side to an image side, a first lens assembly G1, an aperture ST, and a second lens assembly G2.

In the current embodiment, the first lens assembly G1 has positive refractive power and includes in order along the optical axis Z from the object side to the image side. a first lens L1, a second lens L2, and a third lens L3; the second lens assembly G2 has positive refractive power and includes in order along the optical axis Z from the object side to the image side, a fourth lens L4; a fifth lens L5, a sixth lens L6, and a seventh lens L7.

The first lens L1 is a negative meniscus with negative refractive power; an object-side surface S1 of the first lens L1 is a convex surface toward the object side, and an image-side surface S2 of the first lens L1 is a concave surface toward the image side, wherein a surface of the first lens L1 toward the object side is protruded to form the object-side surface S1, a part of a surface of the first lens L1 toward the image side is recessed to form the image-side surface S2, and the optical axis Z passes through the object-side surface S1 and the image-side surface S2 of the first lens L1.

The second lens L2 is a biconcave lens with negative refractive power; an object-side surface S3 of the second lens L2 is a concave surface toward the object side, and an image-side surface S4 of the second lens L2 is a concave surface toward the image side, wherein a surface of the second lens L2 toward the object side is recessed to form the object-side surface S3, a part of a surface of the second lens L2 toward the image side is recessed to form the image-side surface S4, and the optical axis Z passes through the object-side surface S3 and the image-side surface S4 of the second lens L2.

The third lens L3 is a biconvex lens with positive refractive power; an object-side surface S5 of the third lens L3 is a convex surface toward the object side, and an image-side surface S6 of the third lens L3 is a convex surface toward the image side, wherein a surface of the third lens L3 toward the object side is protruded to form the object-side surface S5, a surface of the third lens L3 toward the image side is protruded to form the image-side surface S6, and the optical axis Z passes through the object-side surface S5 and the image-side surface S6 of the third lens L3.

The fourth lens L4 is a biconvex lens (i.e., both of an object-side surface S8 of the fourth lens L4 and an image-side surface S9 of the fourth lens L4 are convex surfaces) with positive refractive power; a part of a surface of the fourth lens L4 toward the object side is protruded to form the object-side surface S8, a surface of the fourth lens L4 toward the image side is protruded to form the image-side surface S9, and the optical axis Z passes through the object-side surface S8 and the image-side surface S9 of the fourth lens L4.

The fifth lens L5 is a biconcave lens (i.e., both of an object-side surface S10 of the fifth lens L5 and an image-side surface S11 of the fifth lens L5 are concave surfaces) with negative refractive power, a part of a surface of the fifth lens L5 toward the object side is recessed to form the object-side surface S10, a part of a surface of the fifth lens L5 toward the image side is recessed to form the image-side surface S11, and the optical axis Z passes through the object-side surface S10 and the image-side surface S11 of the fifth lens L5.

The sixth lens L6 is a biconvex lens (i.e., both of an object-side surface S12 of the sixth lens L6 and an image-side surface S13 of the sixth lens L6 are convex surfaces) with positive refractive power; a part of a surface of the sixth lens L6 toward the object side is protruded to form the object-side surface S12, a surface of the sixth lens L6 toward the image side is protruded to form the image-side surface S13, and the optical axis Z passes through the object-side surface S12 and the image-side surface S13 of the sixth lens L6.

The seventh lens L7 is a negative meniscus with negative refractive power; an object-side surface S14 of the seventh lens L7 is a concave surface toward the object side, and an image-side surface S15 of the seventh lens L7 is a convex surface toward the image side, and the optical axis Z passes through the object-side surface S14 and the image-side surface S15 of the seventh lens L7. As shown in FIG. 2A, the object-side surface S14 of the seventh lens L7 and the image-side surface S13 of the sixth lens L6 are adhered to form a

Additionally, the optical imaging lens 200 further includes an infrared filter L8, wherein the infrared filter L8 is disposed between the seventh lens L7 and an image plane Im, thereby filtering out excess infrared rays in an image light passing through the optical imaging lens 200 to effectively enhance image quality.

In order to keep the optical imaging lens 200 in good optical performance and high imaging quality, the optical imaging lens 200 further satisfies:

$$( 1 ) L 7 R 2 / V 7 < 1 ; \\ ( 2 ) 1 \leq f 3 / f ( 4 , 5 , 6 , 7 ) \leq 3 ; \\ ( 3 ) f 6 / f ( 4 , 5 , 6 , 7 ) \leq 1 ; \\ ( 4 ) - 3.5 \leq f 7 / f ( 4 , 5 , 6 , 7 ) ; \\ ( 5 ) 1 \leq f 3 / f 6 \leq 5 ; - 3.5 \leq f 4 / f 5 ; - 3.5 \leq f 6 / f 7 ; \\ ( 6 ) 1 \leq f ( 4 , 5 , 6 , 7 ) / F \leq 5 ; \\ ( 7 ) - 1 \leq 1 / f 1 + 1 / f 2 + 1 / f 3 + 1 / f 4 + 1 / f 5 + 1 / f 6 + 1 / f 7 \leq 1 ; \\ ( 8 ) V 3 > 25 ; 7 > 25 ; \\ ( 9 ) - 3.5 \leq f ( 4 , 5 , 6 , 7 ) / L 7 R 2 ;$$

wherein F is a focal length of the optical imaging lens 200; f1 is a focal length of the first lens L1; f2 is a focal length of the second lens L2; f3 is a focal length of the third lens L3; f4 is a focal length of the fourth lens L4; f5 is a focal length of the fifth lens L5; f6 is a focal length of the sixth lens L6; f7 is a focal length of the seventh lens L7; f(4,5,6,7) is a focal length of the second lens assembly G2; V3 is an Abbe number of the third lens L3; V7 is an Abbe number of the seventh lens L7; L7R2 is a radius of curvature of the image-side surface S15 of the seventh lens L7.

Parameters of the optical imaging lens 200 of the second embodiment of the present invention are listed in following Table 3, including the focal length F of the optical imaging lens 200 (also called an effective focal length (EFL)), a F-number (Fno), a maximal field of view (DFOV), a radius of curvature (R) of each lens, a distance (D) between each surface and the next surface on the optical axis Z, a refractive index (Nd) of each lens, an Abbe number (Vd) of each lens, the focal length of each lens, a refractive power of each lens, wherein a unit of the focal length, the radius of curvature, and the distance is millimeter (mm). The data listed below are not a limitation of the present invention, wherein the parameters that could be appropriate changed by one with ordinary skill in the art after referring the present invention should still fall within the scope of the present invention.

TABLE 3
F = 1.71 mm; Fno = 2.5; DFOV = 140 deg; TTL =
17.7 mm; 1/2IMG HT = 3.2 mm

| Sur- | | | | | Focal | | Refractive |
|---|---|---|---|---|---|---|---|
| face | R(mm) | D(mm) | Nd | Vd | length | Note | power |
| S1 | 4.424 | 0.95 | 1.536 | 55.98 | −4.159 | L1 | negative |
| S2 | 1.375 | 4.40 | | | | | |
| S3 | −9.779 | 0.66 | 1.535 | 55.71 | −11.138 | L2 | negative |
| S4 | 15.746 | 0.59 | | | | | |
| S5 | 19.362 | 2.34 | 1.755 | 27.51 | 6.395 | L3 | positive |
| S6 | −6.151 | 0.23 | | | | | |
| ST | | 0.45 | | | | Aperture | |
| | | | | | | ST | |
| S8 | 8.195 | 0.93 | 1.545 | 55.99 | 3.941 | L4 | positive |
| S9 | −2.803 | 0.13 | | | | | |
| S10 | −8.949 | 0.65 | 1.661 | 20.37 | −4.641 | L5 | negative |
| S11 | 4.872 | 0.13 | | | | | |
| S12 | 5.184 | 3.37 | 1.620 | 60.29 | 2.859 | L6 | positive |
| S13 | −2.034 | | | | | | |
| S14 | −2.034 | 0.70 | 1.755 | 27.51 | −5.120 | L7 | negative |
| S15 | −4.893 | 0.86 | | | | | |
| | Infinity | 0.20 | 1.517 | 64.17 | | Infrared | |
| | | | | | | filter L8 | |
| | Infinity | 1.00 | | | | | |
| IM | Infinity | | | | | | |

It can be seen from Table 3 that, in the current embodiment, the focal length F of the optical imaging lens 200 is 1.71 mm, and the Fno is 2.5, and the DFOV is 140 degrees, wherein f1=−4.159 mm; f2=−11.138 mm; f3=6.395 mm; f4=3.941 mm; f5=−4.641 mm; f6=2.859 mm; f7=−5.120 mm; f(1,2,3)=50.29 mm, wherein f(1,2,3) is a focal length of the first lens assembly G1; f(4,5,6,7)=4.899 mm.

Additionally, based on the above detailed parameters, detailed values of the aforementioned conditional formula in the second embodiment are as follows:

$$( 1 ) L 7 R 2 / V 7 = - 0.178 ; \\ ( 2 ) f 3 / f ( 4 , 5 , 6 , 7 ) = 1.305 ; \\ ( 3 ) f 6 / f ( 4 , 5 , 6 , 7 ) = 0.584 ; \\ ( 4 ) f 7 / f ( 4 , 5 , 6 , 7 ) = - 1.045 ; \\ ( 5 ) f 3 / f 6 = 2.237 ; f 4 / f 5 = - 0.849 ; f 6 / f 7 = - 0.558 ; \\ ( 6 ) f ( 4 , 5 , 6 , 7 ) / F = 2.865 ; \\ ( 7 ) 1 / f 1 + 1 / f 2 + 1 / f 3 + 1 / f 4 + 1 / f 5 + 1 / f 6 + 1 / f 7 = 0.0189 ; \\ ( 8 ) V 3 = 27.51 ; V 7 = 27.51 ; \\ ( 9 ) f ( 4 , 5 , 6 , 7 ) / L 7 R 2 = - 1.001 .$$

With the aforementioned design, the first lens assembly G1 and the second lens assembly G2 according to the second embodiment satisfy the aforementioned conditions (1) to (9) of the optical imaging lens 200.

Moreover, an aspheric surface contour shape Z of each of the object-side surface S1 of the first lens L1, the image-side surface S2 of the first lens L1, the object-side surface S3 of the second lens L2, the image-side surface S4 of the second lens L2, the object-side surface S8 of the fourth lens L4, the image-side surface S9 of the fourth lens L4, the object-side surface S10 of the fifth lens L5, and the image-side surface S11 of the fifth lens L5 of the optical imaging lens 200 according to the second embodiment could be obtained by following formula:

$$Z = \frac{{ch}^{2}}{1 + \sqrt{1 - ( 1 + k ) {c}^{2} {h}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A4, A6, A8, A10, A12, A14, and A16 respectively represents different order coefficient of h.

The conic constant k of each of the object-side surface S1 of the first lens L1, the image-side surface S2 of the first lens L1, the object-side surface S3 of the second lens L2, the image-side surface S4 of the second lens L2, the object-side surface S8 of the fourth lens L4, the image-side surface S9 of the fourth lens L4, the object-side surface S10 of the fifth lens L5, and the image-side surface S11 of the fifth lens L5 of the optical imaging lens 200 according to the second embodiment and the different order coefficient of A4, A6, A8, A10, A12, A14, and A16 are listed in following Table 4:

TABLE 4

| Surface | K | A4 | A6 | A8 | A10 | A12 | A14 | A16 |
|---|---|---|---|---|---|---|---|---|
| S1 | −1.96E+00 | −7.39E−05 | −1.33E−04 | 7.59E−06 | −1.95E−07 | 2.54E−09 | −1.35E−11 | 0.00E+00 |
| S2 | −9.08E−01 | 1.16E−02 | 1.03E−04 | 1.13E−04 | −3.69E−05 | 1.54E−06 | −2.44E−08 | 0.00E+00 |
| S3 | −7.33E+01 | 1.83E−02 | −2.94E−03 | 1.93E−04 | −2.27E−05 | 3.03E−06 | −1.15E−07 | 0.00E+00 |
| S4 | 7.55E+01 | 3.81E−02 | −3.12E−03 | 4.05E−04 | 2.34E−04 | −3.87E−05 | 3.49E−06 | 0.00E+00 |
| S8 | 1.35E+01 | 2.45E−03 | −1.19E−04 | −8.02E−04 | 5.45E−04 | −2.15E−04 | 1.55E−05 | 0.00E+00 |
| S9 | −1.50E+00 | −1.03E−02 | 8.60E−03 | −2.59E−03 | 8.79E−05 | −8.88E−05 | 2.01E−06 | 0.00E+00 |
| S10 | 1.05E+01 | −1.57E−02 | 8.76E−03 | −1.82E−03 | −4.28E−04 | 2.08E−05 | −1.41E−06 | 0.00E+00 |
| S11 | −5.87E+00 | 4.44E−03 | 1.02E−03 | 1.30E−04 | −2.84E−04 | 4.00E−05 | −2.61E−06 | 0.00E+00 |

Taking optical simulation data to verify the imaging quality of the optical imaging lens 200, wherein FIG. 2B is a diagram showing the longitudinal spherical aberration, the astigmatic field curves, and the distortion of the optical imaging lens according to the second embodiment. The graphics shown in FIG. 2B are within a standard range. In this way, the optical imaging lens 200 of the second embodiment could effectively enhance image quality.

It must be pointed out that the embodiments described above are only some preferred embodiments of the present invention. It is noted that, the parameters listed in Tables are not a limitation of the present invention. All equivalent structures which employ the concepts disclosed in this specification and the appended claims should fall within the scope of the present invention.

What is claimed is:

1. An optical imaging lens, in order from an object side to an image side along an optical axis, comprising:
a first lens assembly comprising, in order from the object side to the image side along the optical axis, a first lens having negative refractive power, a second lens having negative refractive power, and a third lens having positive refractive power, wherein an object-side surface of the first lens is a convex surface toward the object side, and an image-side surface of the first lens is a concave surface toward the image side; both of an object-side surface of the second lens and an image-side surface of the second lens are concave surfaces; both of an object-side surface of the third lens and an image-side surface of the third lens are convex surfaces;
an aperture;
a second lens assembly comprising, in order from the object side to the image side along the optical axis, a fourth lens having positive refractive power, a fifth lens having negative refractive power, a sixth lens having positive refractive power, and a seventh lens having negative refractive power, wherein both of an object-side surface of the fourth lens and an image-side surface of the fourth lens are convex surfaces; both of an object-side surface of the fifth lens and an image-side surface of the fifth lens are concave surfaces; both of an object-side surface of the sixth lens and an image-side surface of the sixth lens are convex surfaces; an object-side surface of the seventh lens is a concave surface toward the object side, and an image-side surface of the seventh lens is a convex surface toward the image side.

2. The optical imaging lens as claimed in claim 1, wherein the object-side surface of the seventh lens and the image-side surface of the sixth lens are adhered to form a compound lens having positive refractive power.

3. The optical imaging lens as claimed in claim 1, wherein the optical imaging lens satisfies: L7R2/V7<1, wherein L7R2 is a radius of curvature of the image-side surface of the seventh lens; V7 is an Abbe number of the seventh lens.

4. The optical imaging lens as claimed in claim 3, wherein the optical imaging lens satisfies: −3.5≤f7/f(4,5,6,7), wherein f7 is a focal length of the seventh lens; f(4,5,6,7) is a focal length of the second lens assembly.

5. The optical imaging lens as claimed in claim 3, wherein the optical imaging lens satisfies: 1≤f3/f635, wherein f3 is a focal length of the third lens; f6 is a focal length of the sixth lens.

6. The optical imaging lens as claimed in claim 3, wherein the optical imaging lens satisfies: −3.5≤f4/f5, wherein f4 is a focal length of the fourth lens; f5 is a focal length of the fifth lens.

7. The optical imaging lens as claimed in claim 3, wherein the optical imaging lens satisfies: −3.5≤f6/f7, wherein f6 is a focal length of the sixth lens; f7 is a focal length of the seventh lens.

8. The optical imaging lens as claimed in claim 3, wherein the optical imaging lens satisfies: 1≤f(4,5,6,7)/F≤5, wherein f(4,5,6,7) is a focal length of the second lens assembly; F is a focal length of the optical imaging lens.

9. The optical imaging lens as claimed in claim 3, wherein the optical imaging lens satisfies: 1≤f3/f(4,5,6,7)≤3, wherein f3 is a focal length of the third lens; f(4,5,6,7) is a focal length of the second lens assembly.

10. The optical imaging lens as claimed in claim 3, wherein the optical imaging lens satisfies: f6/f(4,5,6,7)≤1, wherein f6 is a focal length of the sixth lens; f(4,5,6,7) is a focal length of the second lens assembly.

11. The optical imaging lens as claimed in claim 3, wherein the optical imaging lens satisfies: −1≤1/f1+1/f2+1/f3+1/f4+1/f5+1/f6+1/f7≤1, wherein f1 is a focal length of the first lens; f2 is a focal length of the second lens; f3 is a focal length of the third lens; f4 is a focal length of the fourth lens; f5 is a focal length of the fifth lens; f6 is a focal length of the sixth lens; f7 is a focal length of the seventh lens.

12. The optical imaging lens as claimed in claim 3, wherein the optical imaging lens satisfies: V3>25, wherein V3 is an Abbe number of the third lens.

13. The optical imaging lens as claimed in claim 3, wherein the optical imaging lens satisfies: V7>25.

14. The optical imaging lens as claimed in claim 3, wherein the optical imaging lens satisfies: −3.5≤f(4,5,6,7)/L7R2, wherein f(4,5,6,7) is a focal length of the second lens assembly.

15. An optical imaging lens, in order from an object side to an image side along an optical axis, comprising:
a first lens assembly comprising, in order from the object side to the image side along the optical axis, a first lens having negative refractive power, a second lens having negative refractive power, and a third lens having positive refractive power;
an aperture;
a second lens assembly comprising, in order from the object side to the image side along the optical axis, a fourth lens having positive refractive power, a fifth lens having negative refractive power, a sixth lens having positive refractive power, and a seventh lens having negative refractive power, wherein an object-side surface of the seventh lens and an image-side surface of the sixth lens are adhered to form a compound lens having positive refractive power;
wherein the optical imaging lens satisfies: L7R2/V7<1; L7R2 is a radius of curvature of an image-side surface of the seventh lens; V7 is an Abbe number of the seventh lens.

16. The optical imaging lens as claimed in claim 15, wherein the optical imaging lens satisfies: −3.5≤f7/f(4,5,6,7), wherein f7 is a focal length of the seventh lens; f(4,5,6,7) is a focal length of the second lens assembly.

17. The optical imaging lens as claimed in claim 15 wherein the optical imaging lens satisfies: 1≤f3/f635, wherein f3 is a focal length of the third lens; f6 is a focal length of the sixth lens.

18. The optical imaging lens as claimed in claim 15, wherein the optical imaging lens satisfies: −3.5≤f4/f5, wherein f4 is a focal length of the fourth lens; f5 is a focal length of the fifth lens.

19. The optical imaging lens as claimed in claim 15, wherein the optical imaging lens satisfies: −3.5≤f6/f7, wherein f6 is a focal length of the sixth lens; f7 is a focal length of the seventh lens.

20. The optical imaging lens as claimed in claim 15 wherein the optical imaging lens satisfies: 1≤f(4,5,6,7)/F≤5, wherein f(4,5,6,7) is a focal length of the second lens assembly; F is a focal length of the optical imaging lens.

21. The optical imaging lens as claimed in claim 15, wherein the optical imaging lens satisfies: 1≤f3/f(4,5,6,7)≤3, wherein f3 is a focal length of the third lens; f(4,5,6,7) is a focal length of the second lens assembly.

22. The optical imaging lens as claimed in claim 15, wherein the optical imaging lens satisfies: f6/f(4,5,6,7)≤1, wherein f6 is a focal length of the sixth lens; f(4,5,6,7) is a focal length of the second lens assembly.

23. The optical imaging lens as claimed in claim 15, wherein the optical imaging lens satisfies: −1≤1/f1+1/f2+1/f3+1/f4+1/f5+1/f6+1/f7≤1, wherein f1 is a focal length of the first lens; f2 is a focal length of the second lens; f3 is a focal length of the third lens; f4 is a focal length of the fourth lens; f5 is a focal length of the fifth lens; f6 is a focal length of the sixth lens; f7 is a focal length of t the seventh lens.

24. The optical imaging lens as claimed in claim 15, wherein the optical imaging lens satisfies: V3>25, wherein V3 is an Abbe number of the third lens.

25. The optical imaging lens as claimed in claim 15, wherein the optical imaging lens satisfies: V7>25.

26. The optical imaging lens as claimed in claim 15, wherein the optical imaging lens satisfies: −3.5≤f(4,5,6,7)/L7R2, wherein f(4,5,6,7) is a focal length of the second lens assembly.
